(19) United States
(12) Patent Application Publication
(10) Pub. No.: US 2009/0045374 A1
(43) Pub. Date: Feb. 19, 2009

(54) ELECTRICALLY CONDUCTIVE, MAGNETIC COMPOSITE MATERIAL, PROCESS FOR ITS PRODUCTION, AND ITS USE

(75) Inventors: Dirk LAWRENZ, Hassloch (DE); Ingolf Hennig, Neulussheim (DE); Andrey Karpov, Mannheim (DE); Stefan Kirsch, Nieder-Olm (DE); Hartmut Hibst, Schriesheim (DE); Juergen Kaczun, Wachenheim (DE); Uta Holzenkamp, Lambsheim (DE); Stephen Ems, Wareford, WI (US); Harry Thomas Mills, Racine, WI (US); Paul Edwin Gloor, Grosse Ile, MI (US)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/192,610

(22) Filed: Aug. 15, 2008

(30) Foreign Application Priority Data
Aug. 16, 2007 (EP) 07114411.7

(51) Int. Cl. H01F 1/00; C01G 49/08

(52) U.S. Cl. 252/62.56; 252/62.51 R

(57) ABSTRACT

Electrically conductive, magnetic composite material, comprising
(A) pulverulent, inorganic, magnetic material which is electrically not or only poorly conductive, and
(B) an electrically conductive material, selected from the group consisting of pulverulent and liquid carbon-comprising organic materials and pulverulent carbon allotropes,
   in a ratio by weight of (A):(B)=from 1:100 to 100:1; a process for its production, and its use, and also ferrimagnetic mixed oxide (A) of the general formula I:

M″M′″O₄ (I),

in which M″ is a first metal component which comprises divalent metal cations; and M′″ is a second metal component which comprises trivalent metal cations; capable of production by reacting, in a quantitative ratio such that the resultant ferromagnetic mixed oxide (A) is electrically neutral, divalent metal cations M″ and trivalent metal cations M′″ in aqueous solution and/or dispersion, comprising at least one electrically conductive material (B) and/or at least one material which differs therefrom and which is a binder (C) which dries physically or else is crosslinkable thermally and/or by actinic radiation.

### FIELD OF THE INVENTION

The present invention relates to a novel, electrically conductive, magnetic composite material. The present invention further relates to a novel process for the production of an electrically conductive, magnetic composite material. The present invention also relates to the use of the novel, electrically conductive, magnetic composite material, and of the electrically conductive, magnetic composite material produced by the novel process.

### PRIOR ART

When foods are directly heated in a microwave oven, they often have a moist, soggy consistency. If the food is a bread product, it sometimes becomes leathery, differing from the same product not heated in a microwave oven. The crust of some products, for example pizza mixes, develops an unusual structure, which is either soft or leathery and is therefore not at all attractive. It is moreover generally not possible to brown the surface of foods, and this is particularly important for the heating process and development of flavor in meat, eggs, bread, and vegetables, including potatoes, for example finely cut sauté potatoes, or French fries, or grilled potatoes.

In order to eliminate this fundamental problem, composite materials have been previously proposed which absorb microwaves and convert the microwave energy into thermal energy. The thermal energy generated is then used for the heating of the foods. These known composite materials comprise, for example, ferrites or carbon particles as materials that absorb microwaves (cf. also the German laid-open specification DE 27 45 307 or the American patent U.S. Pat. No. 4,518,651).

However, these known composite materials have disadvantages.

For example, the ferrites exhibit only a comparatively small rise in temperature on irradiation with microwaves, and this is not sufficient for the browning of foods. To improve effectiveness, external magnetic fields matched to the properties of the materials have to be used, or layer weights in the region of 300 g/m² have to be used, but this is not cost-effective. However, even using these measures, the thermal energy generated is often only adequate for heating adhesives sufficiently to produce or release an adhesive bond (cf. also the International patent application WO 03/054102 A1).

When carbon particles are used, for example graphite particles or carbon black, heat generation is often not controllable, and the result can therefore be pyrolysis of the packaging material and/or of the food. This can extend as far as ignition of the packaging material.

Furthermore, the composite materials known hitherto have the disadvantage that their production requires that the ferrites be homogeneously dispersed in the other constituents of the composite materials, and this often requires complicated process technology and high energy costs.

Overall, it has not hitherto been possible to use ferrites or carbon particles to produce composite materials which absorb microwaves and which on irradiation with microwaves under the usual and known conditions of a microwave oven for the household sector (microwave frequency 2.455 GHz; usual radiative power 900 W) exhibit a rapid but controlled temperature rise up to a constant temperature level, where the temperature level reached remains substantially constant during further irradiation. In particular, it has not been possible to achieve a temperature rise ΔT of from 90 to 140° C. within a period of 100 s, where the temperature level reached also remains substantially constant during further irradiation lasting up to 300 s. If the temperature rise is too low, the foods cannot be browned or cooked. If the temperature rise is too high, there is a risk that the foods and/or the packaging material decompose and carbonize.

### OBJECT

It is an object of the present invention to provide a novel, electrically conductive, magnetic, in particular ferrimagnetic, composite material which eliminates the disadvantages of the prior art.

In particular, the intention is that the novel, electrically conductive, magnetic composite material be capable of production in a simple and highly reproducible manner from readily accessible and thermally stable materials. The intention here is especially that the process technology for incorporation of ferrimagnetic materials, such as ferrites, be simplified, and that energy costs be substantially reduced.

The intention is that there be capability for wide variation in the material constitution of the novel, electrically conductive, magnetic composite material, thus permitting its performance profile to be matched in excellent manner to the requirements of each individual case.

Even at comparatively small layer weights, the material is to have excellent suitability for the conversion of the energy of electromagnetic radiation, in particular microwave radiation, into thermal energy. On irradiation with microwaves under the usual and known conditions of a microwave oven for household use (microwave frequency 2.455 GHz; usual radiative power 900 W) the material is to exhibit a rapid but controlled temperature rise up to a constant temperature level, where the temperature level reached remains substantially constant during further irradiation. In particular, the novel, electrically conductive, magnetic composite material is intended to permit a temperature rise ΔT of from 90 to 140° C. within a period of 100 s, where the temperature level reached also remains substantially constant during a further period of irradiation of up to 300 s, so that the foods are subjected neither to too little heat nor too much heat, but instead are cooked and browned in an excellent manner.

Overall, the novel, electrically conductive, magnetic composite material is intended to have excellent suitability as packaging material which absorbs microwaves, or as material which absorbs microwaves in packaging materials for foods, and is intended, particularly in this form, to permit the cooking and browning of foods in microwave ovens.

### INVENTIVE ACHIEVEMENT OF OBJECT

Accordingly, the novel, electrically conductive, magnetic composite material has been found, which comprises
(A) at least one pulverulent, inorganic, magnetic material which is electrically not or only poorly conductive, and
(B) at least one electrically conductive material, selected from the group consisting of pulverulent and liquid carbon-comprising organic materials and pulverulent carbon allotropes,
   in a ratio by weight of (A):(B)=from 1:100 to 100:1, and which is hereinafter termed “inventive composite material”.

The novel process for production of an electrically conductive, magnetic composite material, in particular of an inventive composite material, has moreover been found, by
(1) mixing the materials (A) and (B), and also, if appropriate, at least one further functional constituent (C), with one another and homogeneously dispersing the resultant mixture (1),
   this process being hereinafter termed “inventive process”.

Furthermore, the novel use of the inventive composite material and of the electrically conductive, magnetic composite material produced by the inventive process, for the conversion of the energy of electromagnetic radiation into thermal energy, has been found, this being hereinafter termed “inventive use”.

The novel ferrimagnetic mixed oxide (A) of the general formula I has also been found:

M″M′″O₄ (I),

in which the variables are defined as follows:
M″ is a first metal component which comprises at least one type of divalent metal cations; and
M′″ is a second metal component, which comprises at least one type of trivalent metal cations;
   and which can be prepared by reacting in a quantitative ratio such that the resultant ferrimagnetic mixed oxide (A) is electrically neutral, at least one type of divalent metal cations M″ and at least one type of trivalent metal cations M′″ in aqueous solution and/or dispersion, comprising at least one electrically conductive material (B) and/or at least one material which differs therefrom and which is a binder (C) which dries physically or else is crosslinkable thermally and/or by actinic radiation.

The novel ferrimagnetic mixed oxide (A) of the general formula I is hereinafter termed “inventive mixed oxide (A)”.

### ADVANTAGES OF THE INVENTION

In light of the prior art, it was surprising, and not foreseeable by the person skilled in the art, that the object underlying the present invention could be achieved with the aid of the inventive composite material, of the inventive mixed oxide (A), of the inventive process, and of the inventive use.

In particular, the inventive composite material could be produced by the inventive process in a simple and highly reproducible manner from readily accessible and thermally stable materials. Use of the inventive mixed oxide (A) has proven very particularly advantageous for the purposes of the inventive process, thus permitting simplification of the process technology for the production process and substantial reduction of energy cost.

The material constitution of the inventive composite material could be varied widely, thus permitting its performance profile to be matched in excellent manner to the requirements of each individual case.

It was suitable, even at comparatively low layer weights, for the inventive use, i.e. the conversion of the energy of electromagnetic radiation, in particular microwave radiation, into thermal energy. Here, it exhibited, on irradiation with microwaves under the usual and known conditions of a microwave oven for the household sector (microwave frequency 2.455 GHz; usual radiative power 900 W) a rapid but controlled temperature rise up to a constant temperature level, where the temperature level achieved remained substantially constant during further irradiation. In particular, it was possible to achieve a temperature rise ΔT of from 90 to 140° C. within a period of 100 s, where the temperature level achieved also remained substantially constant during further irradiation lasting up to 300 s, the result being that the foods were neither too little heated nor excessively heated, but were cooked and browned in an excellent manner.

Overall, the inventive composite material had excellent suitability as packaging material which absorbs microwaves, or as material which absorbs microwaves in packaging materials for foods, and, in particular in this form, permitted the cooking and browning of foods in microwave ovens. Surprisingly, the foods cooked and browned in this way within a short period had the same excellent consistency as the same foods cooked and/or browned during a longer time, for example in a baking oven.

### DETAILED DESCRIPTION OF THE INVENTION

The first substantial constituent of the inventive composite material is at least one, in particular one, pulverulent inorganic, magnetic, preferably ferromagnetic or ferrimagnetic, in particular ferrimagnetic, material (A) which is electrically not or only poorly conductive.

“Pulverulent” means that the magnetic material (A) is a solid particulate material under the conditions of its handling and of its inventive use.

Electrically not or only poorly conductive materials are also termed dielectrics, these having high resistivity: >10¹⁰ ohms×cm (cf. also Römpp Online, 2007, “Dielektrics”).

In relation to the properties “magnetic”, “ferromagnetic”, and “ferrimagnetic”, reference is made to Römpp Online, 2007, “Magnetische Werkstoffe” [Magnetic materials], “Magnetochemie” [Magnetochemistry], “Ferrite” [Ferrites], and “Ferromagnetika” [Ferromagnetic materials].

The magnetic material (A) preferably has a Curie temperature T_{c}>50° C., preferably >80° C., and in particular >100° C. The Curie temperature T_{c} is the maximum temperature to which a magnetic substance can be heated in the presence of a alternating magnetic or electromagnetic field. It therefore provides intrinsic overheat protection.

The particle size and the particle size distribution of the magnetic material (A) can vary widely and can therefore be matched in excellent manner to the requirements of each individual case. The magnetic material (A) preferably comprises no particles whose size is >2000 nm or >2 μm. It is preferable that the magnetic material (A) also comprises no particles which are so small as to exhibit superparamagnetic behavior. It is particularly preferable that the particle sizes determined by electron microscopy are from 10 to 1000 nm, very particularly from 50 to 800 nm, and in particular from 100 to 500 nm.

It is preferable that the magnetic material (A) is a magnetic oxide material which has preferably been selected from the group of the ferrimagnetic mixed oxides. It is particularly preferable that the ferrimagnetic mixed oxides (A) have the general formula I:

M″M′″O₄ (I).

The variable M″ in the general formula I is a first metal component, which comprises at least one type, in particular one type, of divalent metal cations. It is preferable that the divalent metal cations of the first metal component M″ are selected from the group consisting of the divalent metal cations of iron, cobalt, nickel, manganese, copper, zinc, cadmium, magnesium, calcium, strontium, barium, and europium, in particular manganese.

M′″ in the general formula I is a second metal component, which comprises at least one type of trivalent metal cations, in particular trivalent metal cations of iron.

The stoichiometries of the first and of the second metal component here have been selected so that the ferrimagnetic mixed oxide (A) is electrically neutral.

It is preferable that the ferrimagnetic mixed oxide (A) of the general formula I is selected from the group of the ferrites, particularly from the group of the ferrite spinels. The ferrite spinel (A) is in particular manganese ferrite, MnFe₂O₄.

The ferrites (A) are compounds known per se, which can be prepared with the aid of the following usual and known processes:
i) solid synthesis or ceramic process, in which mixtures of the corresponding oxides or carbonates, if appropriate in the form of pressings, are sintered at temperatures >800° C.:

xZnO+(1−x)MnO+Fe₂O₃═Mn₁₋ₓZnₓFe₂O₄
(cf. also, M. N. Sankarashana Murthy, C. E. Deshpande, P. P. Bakare, Synthesis and Sintering of Active Manganese (II) Zinc Ferrite Powders, Bulletin of the Chemical Society of Japan; 52(2), pages 571 to 573, 1979; or A. Withop, Manganese-Zinc Ferrite Processing, Properties and Recording Performance, IEEE Transactions on Magnetics, volume 14, number 5, September 1978, pages 439 to 441).
ii) Precipitation of the hydroxocarbonates and calcination at temperatures >600° C.:

xZn²⁺+(1−x)Mn²⁺+2Fe³⁺+yOH⁻+zCO₃²⁻═Mn₁₋ₓZnₓFe₂p(OH)_{y}(CO₃)_{z}]

(y+2z=8)→Mn₁₋ₓZnₓFe₂O₄
(cf. also A. Goldman and A. M. Laing, A New Process for Precipitation of Ferrites, Journal de Physique, Colloque C1, supplement to No. 4, volume 38, April 1977, pages C1-297 to C1-301).
iii) Coprecipitation via hydroxides from the aqueous solution and heating to temperatures >60° C., without sintering, by 3 methods:

Method iii-1): Neutralization

xZn²⁺+(1−x)Mn²⁺+2Fe³⁺+8OH⁻═Mn₁₋ₓZnₓFe₂(OH)₈→Mn₁₋ₓZnₓFe₂O₄
(cf. also W. J. Schuele and V. D. Deetscreek, Preparation, Growth, and Study of Ultrafine Ferrite Particles, Journal of Applied Physics, Supplement to 32, No. 3, March 1961, pages 235S to 237S).

Method iii-2): Oxidation

xZn²⁺+(1−x)Mn²⁺+2Fe²⁺+6OH⁻═Mn₁₋ₓZnₓFe₂(OH)₆

Injection of air at temperatures>60° C.→Mn₁₋ₓZnₓFe₂O₄
(cf. also the American patent U.S. Pat. No. 3,822,210).

Method iii-3): Neutralization and Oxidation

xZn²⁺+(1−x)Mn²⁺+2(Fe_{1-z}/Fe³⁺_{z})+(6+2z)OH⁻═Mn₁₋ₓZnₓFe₂(OH)_{6+2z}

Injection of air at temperatures>60° C.→Mn₁₋ₓZnₓFe₂O₄
(cf. also the European patent application EP 0 160 877 A2 or the German laid-open specification DE-A 1 592 470).

It is preferable to use methods iii-2) or iii-3), in particular method iii-3), for preparation of the manganese ferrite whose use is, according to the invention, very particularly preferred:

### Reaction at Room Temperature:

MnSO₄+2FeSO₄+6NaOH═Mn(OH)₂+2Fe(OH)₂+3Na₂SO₄

### Oxidation at 90° C.:

Mn(OH)₂+2Fe(OH)₂+½O₂═MnFe₂O₄+3H₂O

Very particular advantages result when the ferrimagnetic mixed oxide (A) is an inventive mixed oxide (A).

The inventive mixed oxide (A) can be prepared by reacting in a quantitative ratio such that the resultant ferrimagnetic mixed oxide (A) is electrically neutral, at least one type of divalent metal cations M″ and at least one type of trivalent metal cations M′″ in aqueous solution and/or dispersion, in particular suspension, comprising at least one, in particular one, of the electrically conductive materials (B) described below, and/or at least one, in particular one, of the binders (C) which are described below and which differ from the materials (B), and which dry physically and/or can be crosslinked thermally and/or by actinic radiation.

It is preferable here to use the methods iii-1) to iii-3) described above, in particular method iii-1).

The inventive composite material comprises, as second substantial constituent, at least one electrically conductive material (B) which has been selected from the group consisting of pulverulent and liquid, carbon-comprising organic materials and pulverulent carbon allotropes.

Examples of suitable pulverulent, carbon-comprising organic materials (B) are usual and known electrically conductive organic polymers. Examples of electrically conductive organic polymers (B) having good suitability are polyacetylene, polypyrrol, polythiophene, poly(3-hexylthiophene), poly(3,4-ethylenedioxythiophene) (pedot), polyaniline, polyfluorene, polynaphthalene, poly(p-phenylene sulfide), and poly(p-phenylenevinylene).

Examples of suitable liquid, carbon-comprising organic materials (B) are ionic liquids. They are composed exclusively of ions (cations and anions). In principle, ionic liquids are molten salts with low melting point. These are not only the salt compounds liquid at ambient temperature but also all of the salt compounds melting below 100° C. In contrast to conventional inorganic salts, such as sodium chloride (melting point 808° C.), ionic liquids have their lattice energy and symmetry reduced via charge delocalization, and this can lead to freezing points extending as far as −80° C. and below. Because of the numerous possible combinations of anions and cations, ionic liquids can be prepared with very different properties (cf. also Römpp Online 2007, “ionische Flüssigkeiten” [Ionic liquids]. It is preferable that the ionic liquids are liquid at temperatures <100° C., with preference <50° C., and in particular <30° C.

Organic cations that can be used are any of the cations usually used in ionic liquids. They are preferably acyclic or heterocyclic onium compounds.

It is preferable that acyclic and heterocyclic onium compounds are selected from the group consisting of quaternary ammonium, oxonium, sulfonium, and phosphonium cations, or else from uronium, thiouronium, and guanidinium cations, where the single positive charge has delocalization by way of a plurality of heteroatoms.

It is particularly preferable to use quaternary ammonium cations and it is very particularly preferable to use heterocyclic quaternary ammonium cations.

In particular, the heterocyclic quaternary ammonium cations are selected from the group consisting of pyrrolium, imidazolium, 1H-pyrazolium, 3H-pyrazolium, 4H-pyrazolium, 1-pyrazolinium, 2-pyrazolinium, 3-pyrazolinium, 2,3-dihydroimidazolinium, 4,5-dihydroimidazolinium, 2,5-dihydroimidazolinium, pyrrolidinium, 1,2,4-triazolium (quaternary nitrogen atom in 1-position), 1,2,4-triazolium (quaternary nitrogen atom in 4-position), 1,2,3-triazolium (quaternary nitrogen atom in 1-position), 1,2,3-triazolium (quaternary nitrogen atom in 4-position), oxazolium, isooxazolium, thiazolium, isothiazolium, pyridinium, pyridazinium, pyrimidinium, piperidinium, morpholinium, pyrazinium, indolium, quinolinium, isoquinolinium, quinoxalinium, and indolinium cations.

The organic cations described above are species known per se, described in detail by way of example in the following German patent applications
DE 10 2005 055 815 A, page 6, paragraph [0033], to page 15, paragraph [0074],
DE 10 2005 035 103 A1, page 3, paragraph [0014], to page 10, paragraph [0051], and
DE 103 25 050 A1, the paragraph [0060] bridging pages 2 and 3, in conjunction with page 3, paragraph [0011], to page 5, paragraph [0020].

The passages listed from the German patent applications are expressly incorporated herein by way of reference for purposes of more detailed explanation of the present invention.

Inorganic and organic anions that can be used are any of the anions usually used in ionic liquids. Examples of suitable anions are described in detail in the following German patent applications:
DE 10 2005 055 815 A, page 2, paragraph [006] in conjunction with page 15, paragraph [0075], to page 17, paragraph [0088], and
DE 103 25 050 A1, the paragraph [0006] bridging pages 2 and 3, in conjunction with page 5, paragraph [0021].

The passages listed from the German patent applications are expressly incorporated herein by way of reference for purposes of more detailed explanation of the present invention.

Examples of suitable allotropes (B) of carbon are carbon black, graphite, graphenes, fullerenes, nanotubes, and linear forms having sp-hybridized carbon, preferably carbon black, in particular conductive carbon black.

The materials (A) and (B) to be used according to the invention and described above are present intimately mixed with one another in the inventive composite material. These inventive mixtures can naturally be suspensions of materials (A) in the ionic liquids (B) described above, or can be pulverulent mixtures. They are preferably pulverulent mixtures.

The ratio by weight here of the materials (A) and (B) to be used according to the invention in the inventive composite material are (A):(B)=from 1:100 to 100:1, preferably from 1:10 to 50:1, in particular from 1:5 to 10:1.

The inventive composite material composed only of the materials (A) and (B) can itself be used for the inventive use.

However, according to the invention it is advantageous that the inventive composite material is also modified with at least one functional constituent (C).

Functional constituents (C) that can be used are the materials usually used for the production and/or modification of plastics concentrates or of compounded plastics materials, in particular in the form of pellets, aqueous coating materials, and printing inks, conventional coating materials and printing inks based on organic solvents, or of coating materials and printing inks (100% systems) which are free from water and from solvents, preferably of aqueous coating materials, in particular of aqueous paints.

The functional constituents (C) are preferably selected from the group consisting of the engineering thermoplastics which differ from the electrically conductive materials (B), and also binders which dry physically or else are crosslinkable thermally and/or by actinic radiation; crosslinking agents crosslinkable thermally; reactive diluents curable thermally and by actinic radiation; dyes soluble at the molecular level; colorant and/or special-effect, fluorescent, electrically conductive and magnetically shielding pigments different from materials (A) and (B); metal powders; organic and inorganic, transparent or opaque fillers; nanoparticles; light stabilizers; UV absorbers; reversible free-radical scavengers (HALS); antioxidants; deaerators; antifoams; wetting agents; emulsifiers; dispersing agents; slip additives; polymerization inhibitors; catalysts for thermal crosslinking; thermally labile free-radical initiators; photoinitiators; adhesion promoters; leveling agents; moisture retaining agents; film-forming auxiliaries; rheology auxiliaries; flame retardants; corrosion inhibitors; powder-flow aids; waxes; siccatives; biocides, and matting agents.

Examples of functional constituents (C) having particularly good suitability are known from
Römpp Lexikon Lacke and Druckfarben, Georg Thieme Verlag, Stuttgart, N.Y., 1998, “Bindemittel” [Binders], “Brandschutzmittel” [Flame retardants], “Dispergier(hilfs)mittel” [Dispersing agents], “Druckfarben” [Printing inks], “Härtung” [Curing], “Photoinitiatoren” [Photoinitiators] and “Reactivverdünner” [Reactive diluents];
Dieter Stoye and Werner Freytag (editors), Paints Coatings and Solvents, Second, Completely Revised Edition, Wiley-VCH, Weinheim, N.Y., 1998, pages 3 to 171 and 327 to 373;
Johann Bieleman, Lackadditive, Wiley-VCH, Weinheim, N.Y., 1998, pages 9 to 374; or
DE 199 48 004 A1, page 16, line 15, to page 17, line 5.

The passages listed are expressly incorporated herein by way of reference for purposes of more detailed explanation of the present invention.

Other suitable, usual and known functional constituents (C) are found in
R. H. Leach and C. Armstrong (editors), The Printing Ink Manual, fourth edition, London: Blueprint, 1988; Reprint 1991;
P. Laden (editor), Chemistry and Technology of Water Based Inks, London: Blackie, 1997;
the international patent applications WO 2006/034230 A1 and WO 2004/081127 A1
the European patent application EP 0 679 703 B1 or
the American patent U.S. Pat. No. 4,954,556.

For the purposes of the present invention “actinic radiation” means electromagnetic radiation, such as infrared radiation, near-infrared (NIR), visible light, UV radiation, X-rays, and gamma-radiation, in particular UV radiation, and also particle beams, such as electron beams, beta radiation, proton beams, neutron beams, and alpha-radiation, in particular electron beams.

It is preferable that the inventive composite material takes the form of a paint, a printing ink or a compounded plastics material or a plastics concentrate.

The inventive paint preferably comprises, as functional constituents (C) water; binders, such as dispersed polymers and copolymers of acrylates, or of methacrylates, styrene, butadiene, vinyl acetate, acrylic acid, propylene, ethylene, or acrylonitrile, or water-soluble or readily water-dispersible polymers based on natural products, such as starch, chitosan, or casein, or polymers or copolymers of acrylic acid, of methacrylic acid, of acrylic esters, or of methacrylic esters, or acrylamide, methacrylamide, vinylformamide, acrylonitrile, maleic acid or maleic anhydride; release aids, such as calcium stearate; anionic dispersing agents, such as polyacrylate acids, polyphosphates, or anionically modified polymers based on acrylamide or vinylpyrrolidone; cationic dispersing agents; steric dispersing agents, such as starch, dextrins, alginates, or neutral polyacrylamides, or poly(vinylformamides); rheology aids, such as water-soluble or water-swellable thickeners based on natural products, such as starch, modified starch, carboxymethylcellulose, or cellulose ethers, or polymers or copolymers of acrylic acid of methacrylic acid, of acrylic esters, or of methacrylic esters, or acrylamide, vinylformamide, acrylonitrile, maleic acid or maleic anhydride; moisture-retaining agents, and/or colorants, such as the dyes and pigments described in Römpp Online, 2007, “Druckfarben” [Printing inks], and in the German patent applications DE 199 48 004 A1, page 14, lines 8 to 18, or DE 102 40 972 A1, page 4, paragraph [0022] to [0025].

The inventive printing ink preferably comprises, as functional constituents (C), water; solvents, such as mono- or polyhydric alcohols, esters, ketones, aromatic or aliphatic hydrocarbons, lactones, N-methylpyrrolidone, ethers or ether alcohols; binders, such as polymers based on natural products, such as rosin, schellack, casein, cellulose nitrate, cellulose acetate, cellulose propionate, or cellulose butyrate, cellulose ethers, carboxymethylcellulose, drying or non-drying oils, or natural rubber, or synthetic polymers or copolymers, such as synthetic rubber, chlorinated rubber, styrene-isoprene-styrene block copolymers or styrene-butadiene-styrene block copolymers, hydrocarbon resins, phenolic resins, amino resins, aldehyde resins, or ketone resins, alkyde resins, polyesters, polyamides, polyurethanes, epoxy resins, polyvinyl chloride, polyvinylidene dichloride, polyvinyl acetate, polyvinyl alcohol, polyvinylpyrrolidone, polyvinyl ethers, polyacrylates, polymethacrylates, styrene copolymers, ethylene-acrylic acid copolymers, or maleic anhydride copolymers; plasticizers; adhesion promoters; waxes; lubricants; wetting agents; dispersing agents; crosslinking agents; antifoams; thickeners; photoinitiators; stabilizers; biocides; and/or reactive diluents or binders curable by actinic radiation, e.g. epoxy acrylates, polyether acrylates, polyester acrylates, polyurethane acrylates, or acrylated polyacrylates or acrylated polymethacrylates, which may have been modified by amines. For further details, express reference is made to the publications cited above.

The inventive compounded plastics material preferably comprises, as functional constituent (C), an engineering thermoplastic, such as polyethylene terephthalate, polyamide, or polyurethane.

The material constitution of the inventive composite material which is described above and which is composed of the constituents (A), (B), and (C), but in particular the constitution of the inventive paint, of the inventive printing ink, and of the inventive plastics concentrate or of the inventive compounded plastics material, can vary exceptionally widely and can thus be matched in excellent manner to the requirements of each individual case. The amounts used of the functional constituents (C) are generally those which are usual and known and which are typical and advantageous for the respective application sector (paint, printing ink, plastics concentrate). It is significant here that the relevant inventive composite material can be prepared in a simple manner, in particular by the inventive process, and can be further processed for the inventive use with the aid of the processes and apparatuses which are usual and known for the relevant application sector.

The constitution of inventive paint is preferably such that it can be applied without difficulty with the aid of the usual and known application methods, such as blade coating, film-pressure coating, curtain coating, or spray coating.

The constitution of inventive printing ink is preferably such that it can be printed with the aid of the usual and known printing processes (cf. also Römpp Online, 2007, “Druckverfahren” [Printing processes].

The constitution of the inventive plastics concentrate is preferably such that it can be extruded with the aid of the usual and known extrusion processes.

The respective constitution is also influenced by any intention that the inventive composite material is then to be dried physically or to be curable thermally and/or by actinic radiation. The person skilled in the art can therefore, on the basis of that person's general technical knowledge, if appropriate with the aid of a few preliminary experiments, formulate constitutions which have particularly good suitability for the respective application sector.

Particularly advantageous inventive composite materials are preferably composed, in each case based on an inventive composite material, of
from 10 to 90% by weight, preferably from 20 to 85% by weight, and in particular from 30 to 80% by weight, of (A),
from 1 to 50% by weight, preferably from 2 to 40% by weight, and in particular from 3 to 35% by weight, of (B), and
from 1 to 60% by weight, preferably from 2 to 55% by weight, and in particular from 3 to 55% by weight, of (C).

It is preferable that the inventive composite material takes the form of a solid layer at temperatures of up to 200° C., preferably up to 220° C., and in particular up to 240° C. In particular, the solid layer composed of the inventive composite material is free from constituents, in this temperature range, which are volatile, and/or decompose.

The surface resistance of the layer composed of the inventive composite material is preferably from 30 to 100 000 ohms, with preference from 40 to 50 000 ohms, and in particular from 100 to 50 000 ohms.

The weight of the layer composed of the inventive composite material is preferably from 2 to 50 g/m², with preference from 4 to 40 g/m², and in particular from 6 to 30 g/m².

It is preferable that the location of the layer of the inventive composite material is on a substrate.

The substrate can be composed of a very wide variety of materials. It is significant for the selection of the material that under the conditions of the inventive use they do not interact with electromagnetic radiation, in particular microwave radiation, and they are thermally stable. It is therefore preferable that the substrate material is not magnetizable and is electrically not or only poorly conducting. It is preferable that the substrate material is selected from the group consisting of plastic, glass, ceramic, textiles, materials based on cellulose, and composites thereof. It is preferable to select materials based on cellulose, in particular paper, paperboard, or based on plastics, preferably polyamide or polyester, in particular polyethylene terephthalate or nylon-6, preferably with a layer thickness of from 10 μm to 1 mm, with preference from 20 to 600 μm, and in particular from 30 to 400 μm.

The substrate can be composed of one layer or can itself be a laminate composed of at least two layers, which differ from one another in material and/or in structure.

In particular, the substrate is dimensionally stable even at relatively high temperatures, preferably up to 260° C., and this means that on heating it does not deform, and in particular does not shrink, or expand markedly, or melt.

The substrate can be planar with any desired exterior outline, for example in the form of a film or sheet, or can have been molded in three dimensions. It can have elevations and depressions, such as grooves, raised points, or depressed points, the distribution of these across the substrate taking the form of a grid. It preferably takes the form of usual and known packaging, preferably of food packaging, in particular of packaging for foods which are intended to be baked and browned, examples being popcorn, pastry products, rolls, bread, cake, filled baguettes, pizza mixture, fish fillets, or steaks, the location of the inventive composite material here or of the layer composed thereof is on the inner side of the packaging in immediate or indirect, preferably indirect, contact with the food.

The inventive composite material or the layer composed thereof can cover the full surface of, or part of, the substrate. In the case of partial cover, the layer composed of the inventive composite material can have been applied in the form of a pattern or image, for example in the form of strips or in the form of points distributed in the form of a grid.

The inventive composite material or the layer composed thereof can have been bonded to the substrate by way of a conventional and known adhesive layer. There can moreover be, between the substrate and the adhesive layer and/or between the adhesive layer and the inventive composite material or the layer composed thereof, another layer which has insulating properties with respect to heat and materials, an example being a vapor barrier. Here again, it is significant for the selection of the materials that, under the conditions of the inventive use, they do not interact with electromagnetic radiation, in particular microwave radiation, and they are thermally stable. Here again, the person skilled in the art can select the suitable materials on the basis of that person's general technical knowledge, if appropriate with the aid of a few preliminary experiments. In particular, the abovementioned substrate materials can be used.

It is preferable that the inventive composite material or the layer composed thereof has also been covered with at least one further layer, which, under the conditions of the inventive use, likewise does not interact with electromagnetic radiation, in particular microwave radiation, and is thermally stable. It is preferable that this layer forms a barrier with respect to water vapor and fat. Here again, the person skilled in the art can select the suitable materials on the basis of that person's general technical knowledge, if appropriate with the aid of a few preliminary experiments. It is preferable that this layer is a polyester foil or polyamide foil, in particular a polyethylene terephthalate foil. However, it is also possible to use commercially available baking foils.

It is preferable that the inventive composite material is produced by the inventive process.

To this end, the materials described above (A) and (B), and also, if appropriate, (C) are mixed with one another in step (1) of the process, and then the resultant mixture (1) is homogeneously dispersed.

It is advantageous in the invention if, in step (1) of the process, the materials (A) and (B) are mixed with one another, and the resultant mixture is homogeneously dispersed in the material (C).

It is also advantageous in the invention if the material (A) is prepared in the presence of the materials (B) and/or (C), and any material (B) or (C) that has not yet been added into them added, and the resultant mixture (1) is homogenously dispersed.

Materials (C) that can be used are any of the functional constituents (C) described above. It is particularly preferable that they are selected from the group consisting of the binders which are described above and which are different from the electrically conductive materials (B), and which are dried physically, or else can be crosslinked thermally and/or by actinic radiation. In particular, the binders (C) are dispersible or soluble in water and/or organic solvents, in particular in water, in particular suspendable.

Very particular advantages are obtained if the material (A), in particular the inventive mixed oxide (A) described above, is prepared in the presence of the material (C), since the inventive mixed oxide (A) obtained simplifies the inventive process and reduces its energy cost significantly.

Step (1) of the process does not provide any special method features, and the usual and known assemblies for mixing and homogenization can be used, examples being stirred tanks, kneaders, extruders, solids mixers, an Ultra-Turrax, in-line dissolvers, countercurrent mixers, stirred mills, homogenizing nozzles, pressure homogenizers, microfluidizers, or static mixers, in particular stirred mills.

Any desired method can be used for further processing and use of the homogenized mixture (1), i.e. the inventive composite material. For the purposes of the inventive process, it is applied in step (2) of the process to one of the substrates described above, which can of been covered by an adhesive layer and/or by a layer providing insulation from heat and/or from materials, thus giving a layer (2) of the homogenously dispersed mixture (1).

The application of the homogeneously dispersed mixture (1) in step (2) of the process does not provide any special method features, and can take place with the aid of the usual and known application processes and application apparatuses, examples being spraying, doctoring, spreading, pouring, dipping, troweling, rolling, and printing.

If the homogeneously dispersed mixture (1) is an inventive paint, the application processes described above, and the corresponding application apparatuses, can be used.

If the homogeneously dispersed mixture (1) is an inventive printing ink, preferably applied in the form of an image, the usual and known printing processes can be used, examples being offset printing, letter press printing, flexographic printing, intaglio printing, screen printing, or inkjet printing, as also can the corresponding printing apparatuses.

If the homogeneously dispersed mixture (1) is a compounded plastics material or a plastics concentrate, the layer (2) and the substrate, and also, if appropriate, an additional layer covering the layer (2), can be bonded to one another via coextrusion. The laminate obtained can also be subjected to a pressure process.

The layer (2) composed of the homogeneously dispersed mixture (1) can itself be supplied to the inventive use, if it has the properties necessary for this purpose which are described above.

For the purposes of the inventive use, however, the layer (2), in step (3) of the process, be physically dried or cured thermally and/or by actinic radiation, to obtain a dried and/or cured layer (3) which is composed of the inventive composite material and which has the properties needed for the inventive use.

The thermal curing process and the physical drying process do not have any special method features, but take place by the usual and known methods, such as heating in a convection oven or by heated rolls, or irradiation with IR lamps. The thermal curing process here can also take place in stages. Another preferred cured method is curing by near-infrared (NIR radiation), which removes water particularly rapidly from wet layers. The thermal curing process and the physical drying process advantageously take place at a temperature of from 40 to 200° C., preferably from 50 to 190° C., and in particular from 60 to 180° C.

The curing by actinic radiation is also carried out by UV radiation and/or electron beams. If appropriate, this curing by actinic radiation can be supplemented from other radiation sources. In the case of electron beams, it is preferable to operate under an inert gas. This can be ensured, for example, by supplying carbon dioxide and/or nitrogen directly to the surface of the layers (2). Again in the case of curing by UV radiation, operations can be carried out under an inert gas or in an oxygen-depleted atmosphere in order to avoid formation of ozone. The usual and known radiation sources and optical auxiliary measures are used for the curing by actinic radiation.

For substrates of complicated shape, in particular packaging, the regions (shadow regions) not accessible to direct radiation, e.g. cavities, folds, and other design-related undercuts, can be hardened using spot sources, small-area sources, or omni-directional sources, associated with an automatic motion device for the irradiation of cavities or angled sections.

The inventive composite material can be used in many ways, for example as material for shielding with respect to electrical and/or magnetic fields. However, it has particular advantages in the inventive use in the conversion of the energy of electromagnetic radiation, preferably microwave radiation, into thermal energy.

It is particularly preferable to use microwave radiation whose frequency is from 100 MHz to 300 GHz. By way of example, microwave radiation in the ISM ranges (Industrial, Scientific and Medical Application) can be used, these covering frequencies from 100 MHz to 200 GHz. Examples of available frequencies are 433 MHz, 915 MHz, 2.455 GHz, and 24.25 GHz, and also the mobile-telephone bands in the range from 890 to 960 MHz, and from 1.71 to 1.88 GHz. The frequencies approved for household microwave ovens can also be used (cf. also Kirk Othmer, Encyclopedia of Chemical Technology, 3rd edition, volume 15, chapter on “Microwave Technology”).

It therefore proves to be a very particular advantage of the inventive use that layers composed of the inventive composite material whose weight is from 2 to 50 g/m², preferably from 4 to 40 g/m², and in particular from 6 to 30 g/m² exhibit a temperature rise ΔT of from 90 to 140° C. on irradiation in a microwave oven (microwave frequency 2.455 GHz; maximum power 900 W) in as little as 100 s, preferably in 75 s, and in particular in 50 s, and the temperature level reached also remains substantially constant during further irradiation lasting up to 300 s.

The thermal energy generated inventively from microwaves can therefore be supplied to a very wide variety of intended uses; in particular, however, it is used for the cooking and browning of packaged foods. The inventive composite material exhibits very particular advantages here in its use as packaging material which absorbs microwaves. For example, the relevant foods are cooked and browned within a short time, while developing excellent perceived flavor and excellent consistency. Perceived flavor and consistency here are completely equivalent to, or indeed better than, the perceived flavor and the consistency of the same foods cooked and browned by other methods, for example in a baking oven.

### EXAMPLES AND COMPARATIVE EXPERIMENTS

### Preparation Example 1

### Preparation of Manganese Ferrite, MnFe₂O₄

An aqueous solution having Fe²⁺ ion content and Mn²⁺ ion content in the atomic ratio 2:1 was prepared by dissolving 1224.6 g FeSO₄. 7H₂O (19.7% by weight of Fe²⁺) and 359.6 g MnSO₄. 5H₂O (33% by weight of % Mn²⁺) in 10 l of water. 20% strength by weight aqueous NaOH was added to the resultant solution under nitrogen (200 l/h), until the pH reached was at least 10. A whitish precipitate formed during this process, composed of Mn(OH)₂ and Fe(OH)₂. The reaction mixture was heated under nitrogen and at constant pH of 10, to 90° C. At this temperature, nitrogen was replaced by air at a constant flow rate of 200 l/h, and the reaction mixture was heated for 4 h. This converted the whitish precipitate into a precipitate composed of fine-particle MnFe₂O₄. The manganese ferrite particles were filtered off, washed in water, and then dried at 80° C. in vacuo. The particle sizes of the manganese ferrite particles determined by electron microscopy were from 100 to 300 nm.

### Examples 1 and 2

### Preparation of Physically Hardening Paints 1 and 2

Paints 1 and 2 were produced in each case from 85 parts by weight of manganese ferrite of preparation example 1, 15 parts by weight of conductive carbon black (example 1: Printex® L6 from Degussa; example 2, Vulcan® XC72 from Cabot Corporation) and 60 parts by weight of an aqueous 50% strength by weight dispersion of a styrene-acrylate copolymer (Acronal® S 728 from BASF AG) by dispersion of the constituents. In order to establish rheological properties suitable for the application processes, they were diluted with an amount of water. Paints 1 and 2 could be applied very easily and were excellent for production of physically dried, solid layers which absorb microwaves.

### Examples 3 and 4 and Comparative Experiments C1 and C2

Production of microwave-absorbing layers 1 and 2 (examples 3 and 4), and also of microwave-absorbing layers comprising manganese ferrite alone (comparative experiment C1) and of microwave-absorbing layers comprising conductive carbon black (comparative experiment C2), on paperboard

For production of the microwave-absorbing layer 1 for example 3, paint 1 from example 1 was used.

For production of the microwave-absorbing layer 2 for example 4, paint 2 from example 2 was used.

Production of the microwave-absorbing layer C1 of comparative experiment C1 used a paint which had been produced by analogy with the production specification of example 1, the only difference being that 100 parts by weight of manganese ferrite from preparation example 1 and 60 parts by weight of Acronal® S728 had been used instead of the mixture composed of manganese ferrite and conductive carbon black.

Production of the microwave-absorbing layer C2 of comparative experiment C2 used a paint which had been produced by analogy with the production specification of example 1, the only difference being that 20 parts by weight of conductive carbon black and 60 parts by weight of Acronal® S728 had been used instead of the mixture composed of manganese ferrite and conductive carbon black.

Paints 1 and 2, and also C1 and C2, were applied to paperboard (Baiersbronn 300 g/m²) and dried at 90° C. in a convection oven, giving layer weights of 17 g/m² (layer 1 of example 3), 15 g/m² (layer 2 of example 4), 24 g/m² (layer C1 of comparative example C1) and 7 g/m² (layer C2 of comparative experiment C2).

Disk-shaped specimens of diameter 4 cm were cut out from the coated paperboard 1, 2, C1, and C2, and the temperature rise ΔT of these during irradiation with microwaves was determined as a function of time.

A commercially available Sharp® R-334 microwave oven with maximum power of 900 W was used for the tests. A glassfiber probe was used for the temperature measurements, with a nonmetallic semiconductor chip composed of GaAs as sensor located at its tip. The band edge of this changed as a function of temperature. The glassfiber probe also comprised a light source and a device for the spectral detection of the position of the band edge. Temperature was calculated from the measured position of the band edge.

The detailed test methods were as follows.

### Step 1:

Prior to testing of the specimens, the microwave oven was brought to a defined condition by placing, in the oven, two polystyrene cups each containing 0.5 l of water. One of the polystyrene cups here was placed at the front on the left-hand side, and the other was placed at the back of the right-hand side. The oven was then operated at maximum power for 8 minutes.

### Step 2:

A calibration was then carried out to determine the performance of the oven. For this, a polystyrene cup with 200 g of water was placed in the middle of the oven. The temperature of the water was measured. The oven was then operated at maximum power for one minute, and then the temperature of the water was again measured, and the temperature rise ΔT was calculated. ΔT was typically about 35° C.

### Step 3:

The glass dish of the oven was removed, and a stack of 3 polystyrene cups was inverted and placed in the middle of the oven, i.e. with the opening downward. A specimen was placed on the base of the uppermost polystyrene cup, on a Teflon disk (diameter 5 cm; thickness 1 mm). The sensor of the glassfiber probe was fixed by mechanical pressure on the surface of the microwave-absorbing layer 1 or 2.

Three specimens of each of the microwave-absorbing layers 1 and 2 were tested. Prior to each individual test, a polystyrene cup with 70 g of water at room temperature was placed at the front left-hand side of the oven, in order to achieve a minimum level of absorption of energy in the oven. For each test, the oven was operated using maximum power for 5 minutes, and the temperature rise of the specimen was recorded as a function of time.

After a total of 6 of these tests, the oven was allowed to cool for one hour. Steps 1 to 3 were then repeated with new specimens.

The layer C2 (conductive carbon black alone) was found to exhibit a temperature rise ΔT>180° C. after as little as a few seconds, and the relevant experiments therefore had to be terminated for safety reasons.

The results from examples 1 and 2 are compared in the table with those of comparative experiment C1.

TABLE
Temperature rise ΔT of layers 1 and 2 (example 3 and 4),
and also C1 (comparative experiment C1) on
irradiation with microwaves

| Example and | | | | |
|---|---|---|---|---|
| comparative | | Temperature rise ΔT, ° C. after | | |
| experiment | Layer weight, g/m² | 100 s | 200 s | 300 s |
| 3 | 17 | 90 ± 10 | 100 ± 5 | 100 ± 15 |
| 4 | 15 | 90 ± 10 | 100 ± 20 | 110 ± 25 |
| C1 | 24 | 30 ± 10 | 40 ± 5 | 50 ± 5 |

The comparison showed that only the layers 1 and 2 of examples 3 and 4 exhibited a rapid temperature rise ΔT to the desired temperature level, and that this temperature level also remained substantially constant during prolonged irradiation. Layers 1 and 2 therefore had excellent suitability for the cooking and browning of foods. In contrast, the temperature rise of the layer C1 was insufficient. Preliminary experiments showed that layer weights of about 300 g/m² would have been necessary to achieve a temperature rise ΔT similar to that of layers 1 and 2. However, these layer weights would not have been economically competitive.

### Example 5

### Preparation of a Zinc Manganese Ferrite in the Presence of a Suspension of a Styrene-Acrylate Copolymer

A solution of 825 g of NaOH in 6 l of water was mixed, with stirring, with 52.1 g of an aqueous 50% strength by weight suspension of a styrene-acrylate copolymer (Acronal® S 728 from BASF AG) at room temperature in a 10 l stirred vessel. A mixture of 1131.9 g Fe₂(SO₄)₃. 6H₂O (22.4% by weight of Fe³⁺), 66.3 g ZnSO₄. 7H₂O (22.2% by weight of Zn²⁺) and 334.3 g MnSO₄. H₂O (32.4% by weight of Mn²⁺) in 1.75 l of water was added dropwise within the period of 5.5 min to the resultant suspension. The suspension was then heated to 80° C. and kept for 30 min at this temperature. After the suspension had been cooled, the solids, composed of zinc manganese ferrite and styrene-acrylate copolymer, were filtered off, washed, and dried at 75° C. in a drying oven for 12 h.

X-ray diffraction measurement on the resultant powder confirmed the formation of zinc manganese ferrite. A crystallite size of about 17 nm was calculated from the full width at half height of the X-ray reflections. This was corroborated by measuring an average particle size of about 20 nm with the aid of transmission electron microscopy (TEM).

### Example 6 and 7

### Production of Physically Hardening Paints 3 and 4

Paints 3 and 4 were produced in each case from 85 parts by weight of zinc manganese ferrite of example 5, 15 parts by weight of conductive carbon black (example 1: Printex® L6 from Degussa; example 2, Vulcan® XC72 from Cabot Corporation) and 60 parts by weight of an aqueous 50% strength by weight dispersion of a styrene-acrylate copolymer (Acronal® S 728 from BASF AG) by dispersion of the constituents. The zinc manganese ferrite of example 5 proved here to be particularly easy to disperse. Paints 3 and 4 were diluted with an amount of water for the application process. Paints 3 and 4 could also be applied very easily and were excellent for production of physically dried, solid layers which absorb microwaves.

### Examples 8 and 9

### Production of Microwave-Absorbing Layers 3 and 4 on Paperboard

Examples 3 and 4 were repeated, the only change being that these zinc manganese ferrite of example 5 was used instead of the manganese ferrite of preparation example 1. The microwave-absorbing layers 3 and 4 obtained exhibited the same excellent temperature rise ΔT as the layers 1 and 2 of examples 3 and 4 (cf. the table).

1. An electrically conductive, magnetic composite material, comprising
(A) at least one pulverulent, inorganic, magnetic material which is electrically not or only poorly conductive, and
(B) at least one electrically conductive material, selected from the group consisting of pulverulent and liquid carbon-comprising organic materials and pulverulent carbon allotropes,
in a ratio by weight of (A):(B)=from 1:100 to 100:1.

2. The electrically conductive, magnetic composite material according to claim 1, wherein the material (A) is ferrimagnetic.

3. The electrically conductive, magnetic composite material according to claim 1 or 2, wherein the magnetic material (A) has a Curie temperature T_{c}>50° C.

4. The electrically conductive, magnetic composite material according to any of claims 1 to 3, wherein the magnetic material (A) has a particle size of from 10 to 1000 nm determined by electron microscopy.

5. The electrically conductive, magnetic composite material according to any one of claims 1 to 4, wherein the magnetic material (A) is a magnetic oxide material.

6. The electrically conductive, ferromagnetic composite material according to claim 5, wherein the magnetic oxide material (A) has been selected from the group of the ferrimagnetic mixed oxides.

7. The electrically conductive, ferromagnetic composite material according to claim 6, wherein the ferrimagnetic mixed oxides (A) have the general formula I:
M″M′″O₄ (I),
in which the variables are defined as follows:
M″ is a first metal component which comprises at least one type of divalent metal cations; and
M′″ is a second metal component, which comprises at least one type of trivalent metal cations;
with the proviso that the stoichiometries of the first and the second metal component have been selected so that the ferrimagnetic mixed oxide (A) is electrically neutral.

8. The electrically conductive, magnetic composite material according to claim 7, wherein the divalent metal cations of the first metal component M″ have been selected from the group consisting of the divalent metal cations of iron, cobalt, nickel, manganese, copper, zinc, cadmium, magnesium, calcium, strontium, barium, and europium.

9. The electrically conductive, magnetic composite material according to claim 8, wherein the divalent metal cations of the first metal component M″ are manganese cations.

10. The electrically conductive, magnetic composite material according to any one of claims 7 to 9, wherein the trivalent metal cations of the second metal component M′″ are trivalent metal cations of iron.

11. The electrically conductive, magnetic composite material according to claim 10, wherein the mixed oxide (A) has been selected from the group of the ferrites.

12. The electrically conductive, magnetic composite material according to claim 11, wherein the ferrite (A) has been selected from the group of the ferrite spinels.

13. The electrically conductive, magnetic composite material according to claim 12, wherein the ferrite spinel (A) is manganese ferrite.

14. The electrically conductive, magnetic composite material according to claim 13, wherein the electrically conductive, carbon-comprising, organic material (B) has been selected from the group consisting of ionic liquids and polymers, and the carbon allotrope (B) has been selected from the group consisting of carbon black, graphite, graphenes, fullerenes, nanotubes, and linear forms having sp-hybridized carbon.

15. The electrically conductive, magnetic composite material according to claim 14, wherein the electrically conductive organic polymers (B) have been selected from the group consisting of polyacetylene, polypyrrol, polythiophene, poly(3-hexylthiophene), poly(3,4-ethylenedioxythiophene), polyaniline, polyfluorene, polynaphthalene, poly(p-phenylene sulfide), and poly(p-phenylenevinylene).

16. The electrically conductive, magnetic composite material according to claim 14, wherein the electrically conductive material (B) is carbon black.

17. The electrically conductive, magnetic composite material according to any one of claims 1 to 16, wherein the materials (A) and (B) have been intimately mixed with one another.

18. The electrically conductive, magnetic composite material according to any one of claims 1 to 17, which comprises
(C) at least one functional constituent.

19. The electrically conductive, magnetic composite material according to claim 18, wherein the functional constituent (C) has been selected from the group consisting of the following materials which differ from the electrically conductive materials (B): binders which dry physically or else are crosslinkable thermally and/or by actinic radiation; crosslinking agents crosslinkable thermally or by actinic radiation; reactive diluents curable thermally or by actinic radiation; dyes soluble at the molecular level; colorant and/or special-effect, fluorescent, electrically conductive and magnetically shielding pigments different from the materials (A) and (B); metal powders; organic and inorganic, transparent or opaque fillers; nanoparticles; light stabilizers; UV absorbers; reversible free-radical scavengers (HALS); antioxidants; water; low- and high-boiling-point (“long”) organic solvents, deaerators; antifoams; wetting agents; emulsifiers; dispersing agents; slip additives; polymerization inhibitors; catalysts for thermal crosslinking; thermally labile free-radical initiators; photoinitiators; adhesion promoters; leveling agents; film-forming auxiliaries; rheology auxiliaries; flame retardants; corrosion inhibitors; powder-flow aids; waxes; siccatives; biocides, and matting agents.

20. The electrically conductive, magnetic composite material according to any one of claims 1 to 19, which at temperatures up to 200° C. takes the form of a solid layer.

21. The electrically conductive, magnetic composite material according to claim 20, wherein the surface resistance of the layer of the electrically conductive, magnetic composite material is from 30 to 100 000 ohms.

22. The electrically conductive, magnetic composite material according to claim 20 or 21, wherein the weight of the layer of the electrically conductive, magnetic composite material is from 2 to 40 g/m².

23. The electrically conductive, magnetic composite material according to any of claims 20 to 22, wherein the location of the layer of the electrically conductive, magnetic composite material is on a substrate.

24. The electrically conductive, magnetic composite material according to claim 23, wherein the substrate material has been selected from the group consisting of plastic, glass, ceramic, textiles, materials based on cellulose, and composites thereof.

25. The electrically conductive, magnetic composite material according to claim 24, wherein the materials are based on cellulose paper and paperboard.

26. The electrically conductive, magnetic composite material according to any one of claims 20 to 25, wherein the layer of the electrically conductive, magnetic composite material has been bonded by way of an adhesive layer to the substrate.

27. The electrically conductive, magnetic composite material according to any of claims 20 to 26, wherein the layer of the electrically conductive, magnetic composite material has been covered by at least one further layer.

28. A process for the production of an electrically conductive, magnetic composite material according to any of claims 1 to 27, which comprises
(1) mixing the materials (A) and (B), and also, if appropriate, (C), with one another and homogeneously dispersing the resultant mixture (1).

29. The process according to claim 28, wherein the materials (A) and (B) are mixed with one another, and the resultant mixture is homogeneously dispersed in the material (C).

30. The process according to claim 28, wherein, in step (1) of the process, the material (A) and at least one material (C) are mixed with one another, before the material (B) is added thereto.

31. The process according to any of claims 28 to 30, wherein the material (C) has been selected from the group consisting of the following materials which are dispersible and/or soluble in water and/or in organic solvents and which differ from the electrically conductive materials (B): binders which dry physically or else are crosslinkable thermally and/or by actinic radiation.

32. The process according to any of claims 28 to 31, wherein the material (A) and the material (C) are mixed with one another by preparing the material (A) in the presence of the material (C), or the material (A) and the material (B) are mixed with one another by preparing the material (A) in the presence of the material (B).

33. The process according to any of claims 28 to 32, wherein
(2) the homogeneously dispersed mixture is applied to a substrate to give a layer (2) of the homogeneously dispersed mixture (1).

34. The process according to claim 33, wherein
(3) the layer (2) is cured and/or dried thermally and/or by actinic radiation, to give a cured and/or dried layer (3) of the electrically conductive, magnetic composite material.

35. The process according to claim 33 or 34, wherein the layer (2) or (3) of the electrically conductive, magnetic composite material is covered by at least one further layer.

36. The process according to any of claims 28 to 35, wherein step (1) of the process uses, as mixing and homogenizing assemblies, stirred tanks, kneaders, extruders, solids mixers, an Ultra-Turrax, in-line dissolvers, countercurrent mixers, stirred mills, homogenizing nozzles, pressure homogenizers, microfluidizers, or static mixers.

37. The process according to any of claims 28 to 36, wherein the application method used in step (2) of the process comprises spraying, doctoring, spreading, pouring, dipping, troweling, rolling, or printing.

38. The use of an electrically conductive, magnetic composite material according to any of claims 1 to 27 or of an electrically conductive, magnetic composite material produced by the process according to any of claims 28 to 37, for conversion of the energy of electromagnetic radiation to thermal energy.

39. The use according to claim 38, wherein the electromagnetic energy is microwave radiation.

40. The use according to claim 38 or 39, wherein the electrically conductive, magnetic composite material is used as packaging material that absorbs microwaves, or as material that absorbs microwaves in packaging materials for food.

41. The use according to claim 40, wherein the packaging material is used for the cooking and browning of the foods.

42. A ferrimagnetic mixed oxide (A) of the general formula I, as defined in any of claims 7 to 13, which can be prepared by reacting, in a quantitative ratio such that the resultant ferrimagnetic mixed oxide (A) is electrically neutral, at least one type of divalent metal cations M″ and at least one type of trivalent metal cations M′″ in aqueous solution and/or dispersion, comprising at least one electrically conductive material (B) and/or at least one material which differs therefrom and which is a binder (C) which dries physically or else is crosslinkable thermally and/or by actinic radiation.

43. The use of the ferrimagnetic mixed oxide (A) according to claim 42 for the production of an electrically conductive, magnetic composite material, as defined in any of claims 1 to 27.
